(19) United States
(12) Patent Application Publication
(10) Pub. No.: US 2026/0171636 A1
(43) Pub. Date: Jun. 18, 2026

(54) OVERCURRENT CIRCUIT BREAKER FOR POUCH CELL BATTERY

(71) Applicant: GUS TECHNOLOGY CO., LTD., Taoyuan City (TW)

(72) Inventors: CHUNG CHIEH CHANG, Taoyuan City (TW); HENG CHEN KUO, Taoyuan City (TW); MING HUEI TSAI, Taoyuan City (TW); CHIH HSING LEE, Taoyuan City (TW); CHING CHI CHENG, Taoyuan City (TW)

(21) Appl. No.: 18/979,335

(22) Filed: Dec. 12, 2024

(51) Int. Cl. H01M 50/583; H01M 50/211; H01M 50/507

(52) U.S. Cl. CPC H01M 50/583; H01M 50/211; H01M 50/507; H01M 2200/103

(57) ABSTRACT

The present invention provides an overcurrent circuit breaker for a pouch cell battery, comprising a first electrical connection plate, a second electrical connection plate, a current-interrupting element, and a protective housing. The first electrical connection plate electrically connects a first busbar of the pouch cell battery, while the second electrical connection plate connects a first electrode. The current-interrupting element forms a current path between the joining plates and is positioned inside a protective housing made of a flame-retardant material with insulating and heat-insulating properties. The overcurrent circuit breaker, located inside the pouch cell battery, provides an active protection for the battery cell module by preventing excessive current during charging or discharging.

### FIELD OF INVENTION

The present invention relates to a component of a pouch cell battery, more particularly an overcurrent circuit breaker designed for use in the pouch cell battery.

### BACKGROUND OF THE INVENTION

A pouch cell battery is a type of ion battery capable of storing and releasing significant amounts of electrical energy. Such batteries are widely used in automotive applications and energy storage systems. The ion battery types referred to herein include, but are not limited to, lithium-ion batteries.

A conventional pouch cell battery comprises a battery cell module, two bus structures, a protective case, and two electrodes. The battery cell module consists primarily of multiple battery cells arranged in parallel, each of which is used to store electrical energy. Each battery cell is equipped with two tabs which act as a positive or a negative pole. The bus structures are positioned at either end of the battery cell module, with each structure containing one or more busbars, and each tab is electrically connected to one adjacent busbar, allowing the battery cells to be interconnected in series or parallel via the tabs and the busbars. The protective case, typically made of metal, houses and secures the battery cell module while providing physical protection. Each electrode is electrically connected to one busbar and interfaces with external power transmission lines or electrical equipment. This configuration enables the battery cell module to supply power to external systems and facilitates the charging of the battery cells via the power transmission lines.

### SUMMARY OF THE INVENTION

The main purpose of the present invention is to provide an overcurrent circuit breaker for a pouch cell battery. In order to achieve this purpose, the present invention employs the following technical solution:

An overcurrent circuit breaker for a pouch cell battery, configured to electrically connect a first busbar and a first electrode of the pouch cell battery, serving as a current channel between the first busbar and the first electrode; the first busbar is configured to electrically connect a battery cell module, and the first electrode is configured to electrically connect an external power source or an external electrical device; wherein,
the overcurrent circuit breaker, comprising a first electrical connection plate, a second electrical connection plate, a current-interrupting element, and a protective housing; wherein the first and second electrical connection plates are constructed from conductive metal plates, with the first electrical connection plate electrically connecting the first busbar and the second electrical connection plate electrically connecting the first electrode; the current-interrupting element is made of a conductive metal having a rated temperature fuse characteristic and electrically connects the first electrical connection plate and the second electrical connection plate to form a current path; and
the protective housing is a shell-like structure made of a flame-retardant material with insulating and heat-insulating properties, connecting the first electrical connection plate and the second electrical connection plate, with the current-interrupting element located inside the protective housing.

The overcurrent circuit breaker, which is located inside the pouch cell battery, provides an active protection for the battery cell module by preventing overheating due to excessive charging currents. It also ensures that the pouch cell battery does not supply electrical energy to the external electrical device with excessive current value.

In addition, the protective housing prevents the current-interrupting element from coming into contact with the external thermally conductive adhesive, thereby reducing or eliminating the influence of the adhesive on the current-interrupting element. This design enhances the accuracy of melting of the current-interrupting element during a current overload.

### BRIEF DESCRIPTION OF THE DRAWINGS

FIG. 1 is a perspective view illustrating a pouch cell battery according to a first embodiment of the present invention;

FIG. 2 is an exploded perspective view illustrating the pouch cell battery according to the first embodiment of the present invention;

FIG. 3 is a perspective view illustrating the connection between the first busbar and the first electrode in the first embodiment;

FIG. 4 is a perspective view of the first embodiment of the present invention;

FIG. 5 is an exploded perspective view of the first embodiment of the present invention;

FIG. 6 is a partial cross-sectional view illustrating the installation of the first embodiment of the present invention;

FIG. 7 is a perspective view illustrating a second embodiment of the present invention; and

FIG. 8 is an exploded perspective view illustrating the second embodiment of the present invention.

### DETAILED DESCRIPTION OF THE PREFERRED EMBODIMENTS

The accompanying drawings illustrate embodiments of an overcurrent circuit breaker for a pouch cell battery. These embodiments are provided for illustrative purposes only and are not intended to limit the construction or scope of the invention as defined in the patent claims.

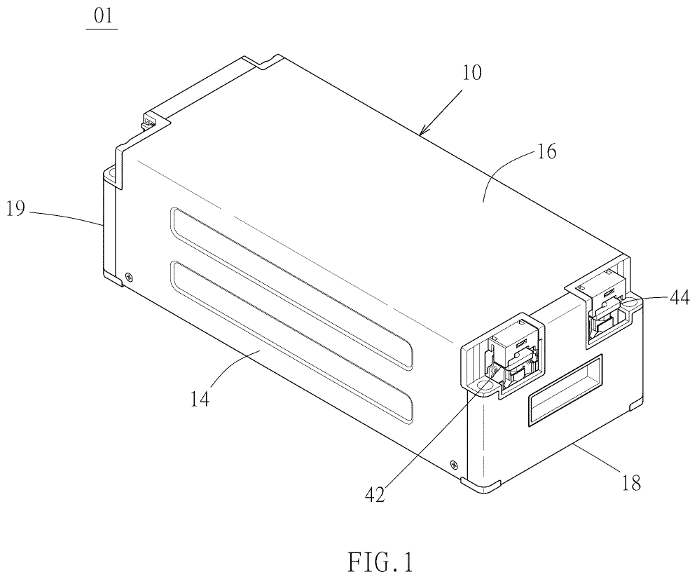

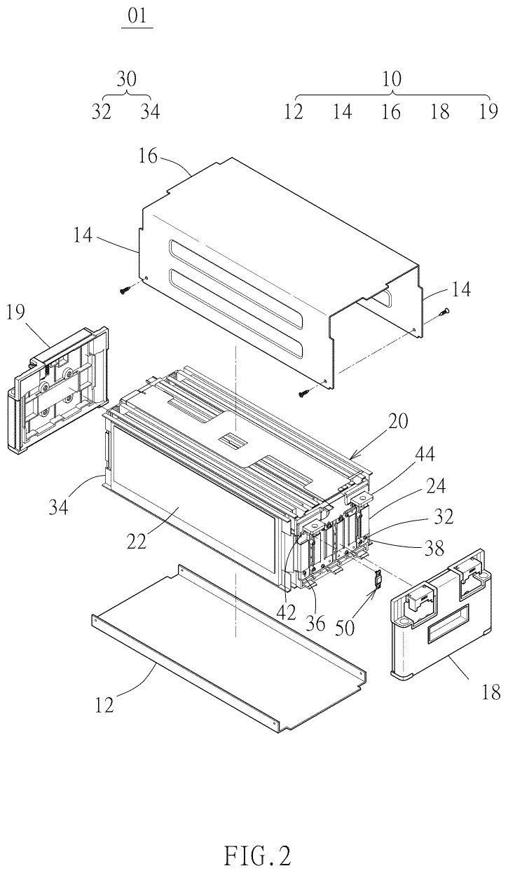

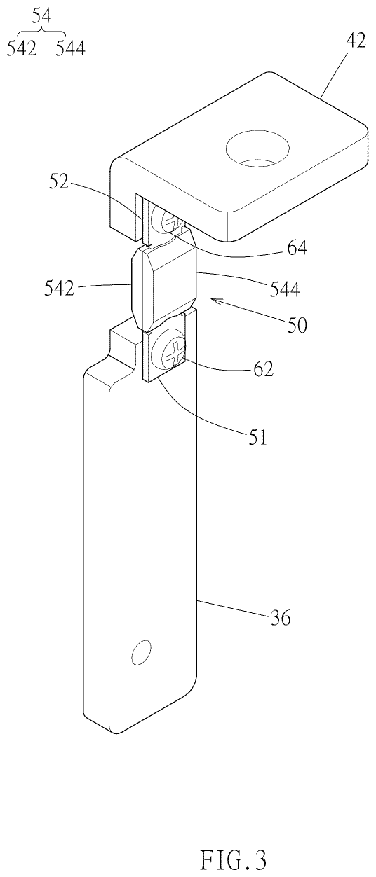

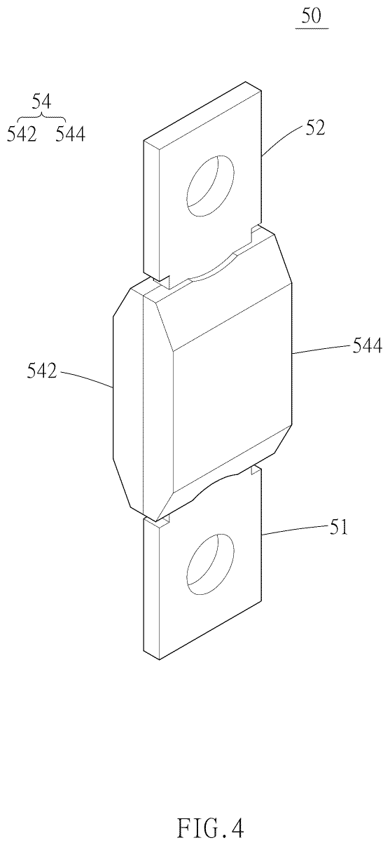

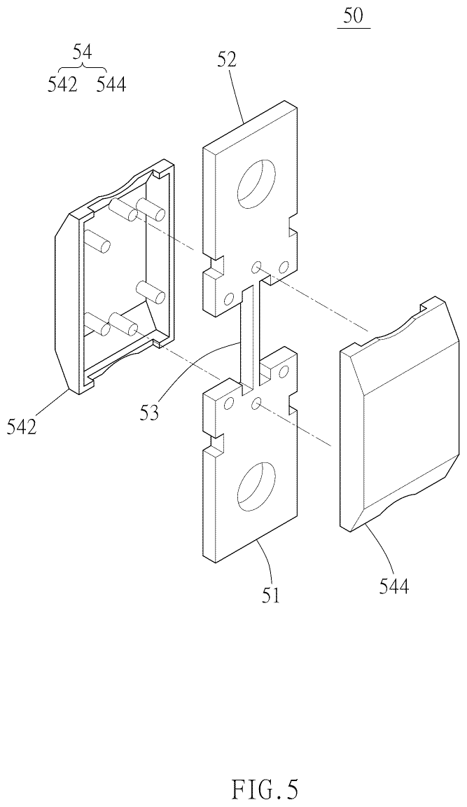

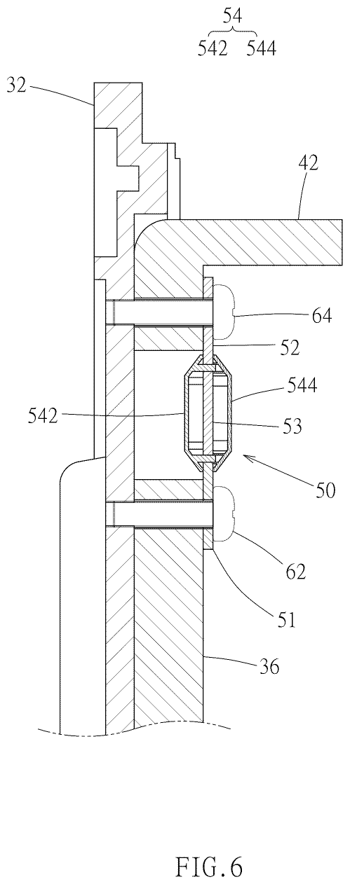

As shown in FIGS. 1 to 6, a pouch cell battery 01 comprises a protective case 10, a battery cell module 20, a bus structure 30, a first electrode 42, a second electrode 44, and an overcurrent circuit breaker 50 as illustrated in the first embodiment. The protective case 10 includes a bottom plate 12, two side plates 14, a cover plate 16, a first terminal cover 18, and a second terminal cover 19. The bottom plate 12 supports the battery cell module 20, the side plates 14 are positioned opposite each other and connected to the bottom plate 12, and the cover plate 16 connects the side plates 14 at their upper edges. The first and second terminal covers 18 and 19 are positioned opposite each other and are connected to the bottom plate 12 and the side plates 14. The battery cell module 20 is positioned between the side plates 14 and the first and second terminal covers 18 and 19 and is thereby securely housed within the protective case 10. This protective case 10 serves to protect the battery cell module 20 from external impacts.

The battery cell module 20 comprises multiple battery cells 22 configured to store electrical energy. Each battery cell 22 includes two tabs 24 that serve as positive and negative poles for the respective battery cells 22.

The bus structure 30 includes a first support seat 32 and a second support seat 34. The first support seat 32 is positioned between the battery cell module 20 and the first terminal cover 18, while the second support seat 34 is positioned between the battery cell module 20 and the second terminal cover 19. The first support seat 32 includes a first busbar 36 and multiple second busbars 38, while the second support seat 34 is equipped with the multiple second busbars 38. The first busbar 36 and each second busbar 38 are electrically connected to the at least one tab 24, thereby enabling the battery cells 22 to be connected in series or in parallel. The first electrode 42 and the second electrode 44 facilitate electrical connection to an external power source (not shown) or an external electrical device (not shown), with the second electrode 44 being electrically connected to the respective second busbar 38.

The overcurrent circuit breaker 50 includes a first electrical connection plate 51, a second electrical connection plate 52, a current-interrupting element 53, and a protective housing 54. Both the first electrical connection plate 51 and the second electrical connection plate 52 are constructed from conductive metal plates. The first electrical connection plate 51 is electrically connected to the first busbar 36, and the second electrical connection plate 52 is electrically connected to the first electrode 42. The current-interrupting element 53, which is made of a conductive metal having a rated temperature fuse characteristic, electrically connects the first electrical connection plate 51 and the second electrical connection plate 52 to form a current path.

Specifically, the first electrical connection plate 51 is fitted with a first bolt 62, which passes through the first busbar 36 and is screwed into the first support seat 32, thereby electrically connecting the first electrical connection plate 51 to the first busbar 36. Similarly, the second electrical connection plate 52 is fitted with a second bolt 64, which passes through the first electrode 42 and is screwed into the first support seat 32, thereby electrically connecting the second electrical connection plate 52 to the first electrode 42.

The protective housing 54 is a shell-like structure made of a flame-retardant material with insulating and heat-insulating properties. It connects the first electrical connection plate 51 and the second electrical connection plate 52, with the current-interrupting element 53 located inside the protective housing 54.

When current passes through the overcurrent circuit breaker 50, the resistive properties of the current-interrupting element 53 cause it to generate heat. When the current exceeds the set threshold, the current-interrupting element 53 overheats and melts, creating an open circuit between the first busbar 36 and the first electrode 42. As a result, the external current cannot enter the battery cell module 20 and the battery cell module 20 also cannot release electrical energy externally.

The overcurrent circuit breaker 50, which is located inside the pouch cell battery 01, provides an active protection for the battery cell module 20. When the external power source charges the battery cell module 20, if the charging current exceeds a high value, the current-interrupting element 53 can melt promptly, preventing the battery cell module 20 from overheating due to excessive charging current. When the pouch cell battery 01 supplies electrical energy to the external electrical device, the overcurrent circuit breaker 50 inside the battery 01 prevents the discharge current from becoming too high, thereby avoiding damage to the external electrical device due to abnormal battery output. If the external electrical device stops working or is damaged due to current abnormalities, this allows for a clear determination of whether the event originated from the power supply of the pouch cell battery 01, thus helping to avoid consumer or commercial disputes.

A first thermally conductive adhesive (not shown) is applied between the first support seat 32 and the first terminal cover 18, and a second thermally conductive adhesive (not shown) is applied between the second support seat 34 and the second terminal cover 19. These thermally conductive adhesives are made of materials with excellent thermal conductivity, thereby improving the external heat dissipation efficiency of the battery cell module 20.

The protective housing 54 can prevent the current-interrupting element 53 from coming into contact with the first thermally conductive adhesive, thereby reducing the potential heat transfer between the current-interrupting element 53 and the adhesive. When the temperature of the current-interrupting element 53 rises, the protective housing 54 can prevent the first thermally conductive adhesive from degrading or even burning due to the heat generated by the current-interrupting element 53, so that the heat generated by the current-interrupting element 53 is not absorbed or dissipated by the thermally conductive adhesive. Conversely, when the heat energy from the battery cell module 20 is dissipated externally through the first thermally conductive adhesive, the protective housing 54 minimizes the likelihood of the current-interrupting element 53 absorbing heat from the adhesive. This ensures that the temperature of the current-interrupting element 53 accurately reflects the current value, while the protective housing 54 reduces the influence of the first thermally conductive adhesive on the current-interrupting element 53, enhancing the accuracy of its melting during a current overload.

The protective housing 54 primarily comprises a first half-shell 542 and a second half-shell 544 joined together. The first half-shell 542 is connected to the first electrical connection plate 51 and the second electrical connection plate 52, while the second half-shell 544 is joined to the first half-shell 542. The current-interrupting element 53 is positioned within the space enclosed by the first and second half-shells 542 and 544.

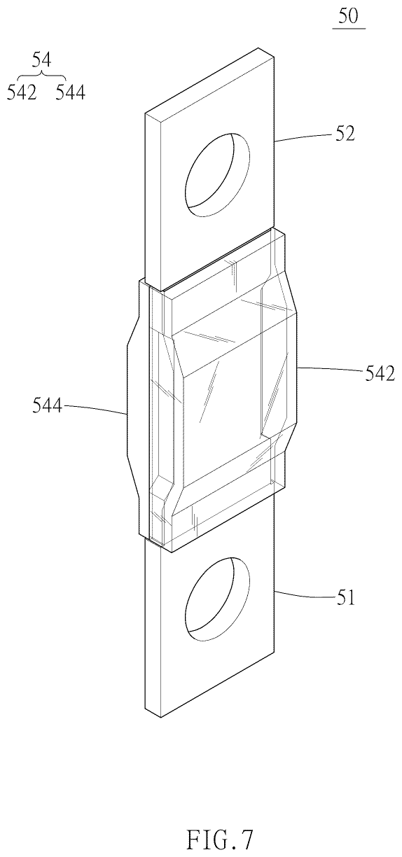

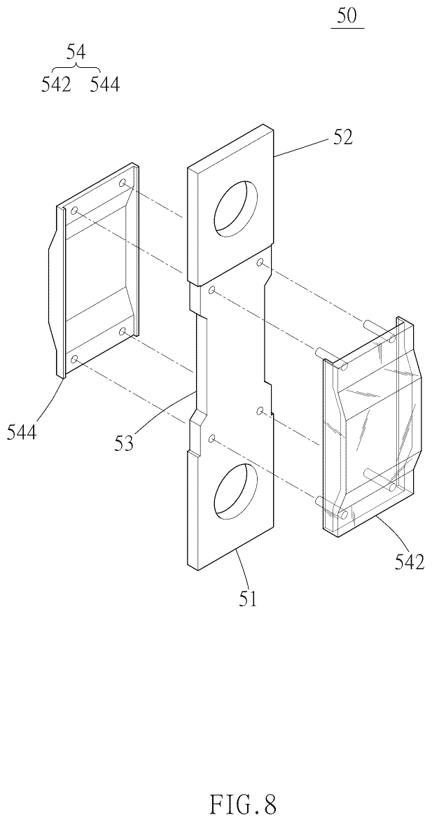

As shown in FIGS. 7 and 8, a second embodiment differs from the first embodiment primarily in that the first half-shell 542 is made of a transparent material. This design allows visual inspection of the condition of the current-interrupting element 53. When the pouch cell battery 01 cannot be charged by the external power source or cannot supply power to the external electrical device, the melting of the current-interrupting element 53 can be observed through the transparent first half-shell 542, thereby improving maintenance convenience.

What is claimed is:

1. An overcurrent circuit breaker for a pouch cell battery, configured to electrically connect a first busbar and a first electrode of the pouch cell battery, serving as a current channel between the first busbar and the first electrode; the first busbar is configured to electrically connect a battery cell module, and the first electrode is configured to electrically connect an external power source or an external electrical device; wherein,
the overcurrent circuit breaker, comprising a first electrical connection plate, a second electrical connection plate, a current-interrupting element, and a protective housing; wherein the first and second electrical connection plates are constructed from conductive metal plates, with the first electrical connection plate electrically connecting the first busbar and the second electrical connection plate electrically connecting the first electrode; the current-interrupting element is made of a conductive metal having a rated temperature fuse characteristic and electrically connects the first electrical connection plate and the second electrical connection plate to form a current path; and
the protective housing is a shell-like structure made of a flame-retardant material with insulating and heat-insulating properties, connecting the first electrical connection plate and the second electrical connection plate, with the current-interrupting element located inside the protective housing.

2. The overcurrent circuit breaker for a pouch cell battery according to Claim 1, wherein the protective housing primarily comprises a first half-shell and a second half-shell joined together, the first half-shell connecting the first electrical connection plate and the second electrical connection plate, and the second half-shell being joined to the first half-shell, with the current-interrupting element positioned between the first and second half-shells.

3. The overcurrent circuit breaker for a pouch cell battery according to Claim 2, wherein the first half-shell is made of a transparent material.
